(19) United States
(12) Patent Application Publication
(10) Pub. No.: US 2014/0354578 A1
(43) Pub. Date: Dec. 4, 2014

(54) METHOD FOR SETTING DRIVING SIGNALS FOR ELECTRODE OF TOUCH PANEL AND DRIVING METHOD FOR TOUCH PANEL

(71) Applicant: TIANJIN FUNAYUANCHUANG TECHNOLOGY CO., LTD., Tianjin (CN)

(72) Inventors: CHIEN-YUNG CHENG, Hsinchu (TW); CHUN-LUNG HUANG, Hsinchu (TW); PO-SHENG SHIH, Hsinchu (TW)

(73) Assignee: TIANJIN FUNAYUANCHUANG TECHNOLOGY CO.,LTD., Tianjin (CN)

(21) Appl. No.: 13/904,272

(22) Filed: May 29, 2013

(51) Int. Cl. G06F 3/044; G06F 3/041

(52) U.S. Cl. CPC G06F 3/044; G06F 3/0416
USPC 345/174

(57) ABSTRACT

A method for setting a driving signal for an electrode of a touch panel is provided. In the method, a varying driving signal is provided to the electrode. The varying driving signal includes a number of initial driving signal values varying with time. An initial capacitance signal value set is detected untouched from the electrode of the touch panel. The initial capacitance signal value set includes a number of varying initial capacitance signal values. The initial capacitance signal value set is generated and corresponds to the varying driving signal. A basic capacitance signal value is preset. A proximate initial capacitance signal value closest to the basic capacitance signal value is selected from the initial capacitance signal value set. The initial driving signal value corresponding to the proximate initial capacitance signal value is set as an optimized driving signal value of the electrode.

### BACKGROUND

1. Technical Field

The present disclosure relates to methods for setting driving signals for electrodes of a touch panel and driving methods for the touch panel.

2. Description of Related Art

At present, capacitive touch panels are commonly driven by providing driving signals to each electrode of the touch panel with an integrated circuit (IC) and capacitance signal values from each electrode are detected in turn. If touches occur on the touch panel, capacitance changes are detected with the IC to recognize positions of touch points. However, conductive wires connecting the electrodes to the IC have impedance and stray capacitances existing therebetween. Thus, the above driving method may cause a detection error of the touch points or decrease detection accuracy.

What is needed, therefore, is to provide a method for setting driving signals for electrodes of a capacitive touch panel and a driving method for the capacitive touch panel that can improve a detection accuracy of touch points operated thereon.

### BRIEF DESCRIPTION OF THE DRAWING

Many aspects of the present disclosure can be better understood with reference to the following drawings. The components in the drawings are not necessarily to scale, the emphasis instead being placed upon clearly illustrating the principles of the present embodiments.

FIG. 1 is a flow chart of one embodiment of a method for setting a driving signal for an electrode of a touch panel.

FIG. 2 is a flow chart of one embodiment of a method for setting an optimized driving signal for the electrode of the touch panel.

FIG. 3 is a flow chart of another embodiment of the method for setting the optimized driving signal for the electrode of the touch panel.

FIG. 4 is a schematic view of an embodiment of a process for confirming a selective range for the optimized driving signal.

FIG. 5 is a schematic top view of an embodiment of the touch panel.

FIG. 6 is a schematic side view of an embodiment of the touch panel.

FIG. 7 shows initial capacitance signal curves of first electrodes of the touch panel varied with a driving signal.

FIG. 8 is a flow chart of one embodiment of a driving method for the touch panel.

FIG. 9 is capacitance signal variation value curves detected from electrodes of the touch panel if a touch point P is acted thereon.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean at least one.

Methods of the present disclosure described below can be applied to a capacitive touch panel. Structurally, the capacitive touch panel includes at least one transparent conductive layer, a plurality of electrodes, and at least one integrated circuit (IC). The plurality of electrodes are spaced from each other and electrically connected with the transparent conductive layer. The at least one IC provides driving signals to the electrodes and detects capacitance signal value changes occurring on the transparent conductive layer to confirm positions of touch points.

A material of transparent conductive layer can be ITO or carbon nanotubes. The at least one IC includes a driving IC providing driving signals to the electrodes and a sensing IC detecting capacitance signal values before and after touches on the touch panel. The driving IC and sensing IC can be integrated in one IC.

In principle, methods of the present disclosure can be applied to a surface capacitive touch panel or a projective capacitive touch panel.

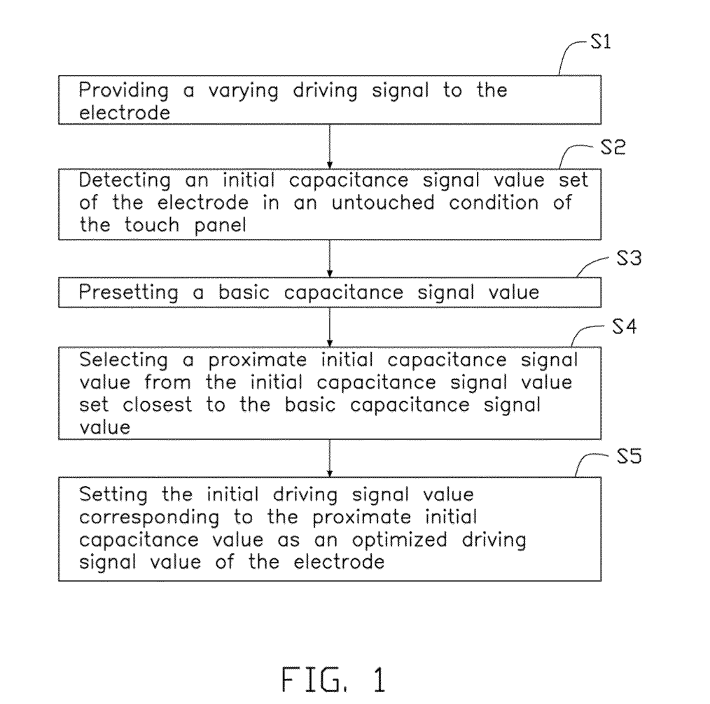

Referring to FIG. 1, one embodiment of a method setting driving signals for electrodes of the touch panel includes the following steps:

S1, providing a varying driving signal to each electrode of the touch panel, the varying driving signal including a plurality of initial driving signal values varied with time;

S2, detecting an initial capacitance signal value set of each electrode in an untouched condition of the touch panel, the initial capacitance signal value set including a plurality of varied initial capacitance signal values of each electrode, the initial capacitance signal value set being generated by and corresponding to the varying driving signal;

S3, presetting a basic capacitance signal value;

S4, selecting a proximate initial capacitance signal value from the initial capacitance signal value set closest to the basic capacitance signal value; and

S5, setting the initial driving signal value corresponding to the proximate initial capacitance signal value as an optimized driving signal value of the electrode.

In the present disclosure, the signal value is referred to a constant value at a specific time, and a varied signal has different signal value changing with time. In step S1, the varying driving signal to each electrode is provided with the IC in the untouched condition of the touch panel. The varying driving signal can be provided to the plurality of electrodes successively or simultaneously. The varying driving signal can be a current signal or a voltage signal. The plurality of initial driving signal values is different from each other. In one embodiment, the varying driving signal is a continuous analog current signal including the plurality of initial driving signal values varying from small to large within a time period. The term “from small to large” means that the initial driving signal value increases with time increasing.

In step S2, the varying driving signal provided to the electrode can generate a corresponding initial capacitance signal consisting of the plurality of initial capacitance signal values. Therefore, there is a one-to-one correspondence between the plurality of initial driving signal values and the plurality of initial capacitance signal values.

Each initial capacitance signal is a set of initial capacitance signal values. The step S2 can repeat several times to obtain a plurality of initial capacitance signal value sets. The initial capacitance signal values in different initial capacitance signal value sets which correspond to the same initial driving signal value can be averaged to obtain an averaged initial capacitance signal value. The plurality of initial capacitance signal value sets are separately averaged to obtain an averaged initial capacitance signal value set. The averaged initial capacitance signal value set can be used in steps S3 and S4 to set the optimized driving signal value for each electrode. The averaged initial capacitance signal value set can be used to precisely set the optimized driving signal value for each electrode.

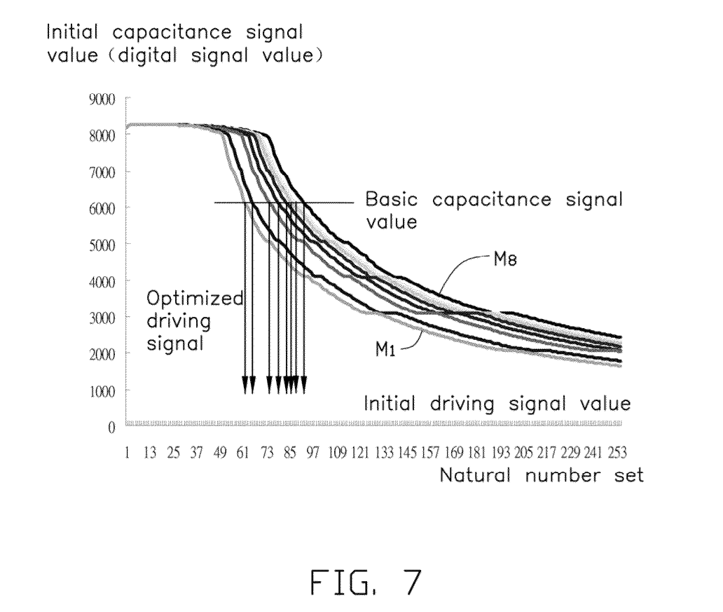

In step S3, the basic capacitance signal value preset depends on the IC. The IC has an optimal detecting range of capacitance signal values. In the optimal detecting range, capacitance signal values vary greatly before and after touches on the touch panel. In one embodiment, the capacitance signal value varying the greatest in the optimal detecting range is selected as the basic capacitance signal value. Referring to FIG. 7, the initial capacitance signal having the plurality of initial capacitance signal values of each electrode can be shown as an initial capacitance signal value curve on the figure (such as the capacitance curve of the electrode MD. There are many tangents of the initial capacitance signal value curve at different initial capacitance signal values. The initial capacitance signal value corresponding to one tangent having a slope with an absolute value equal to 1, is preset as the basic capacitance signal value. The capacitance signal varies linearly and greatly near the basic capacitance signal value and can improve detection precision of touch point positions.

The optimized driving signal value of each electrode can be set by searching the proximate initial capacitance signal value from the initial capacitance signal value set separately. The detecting step and the selecting step can proceed at the same time. Each initial capacitance signal value can be compared with the basic capacitance signal value after being detected to determine whether it is the proximate initial capacitance signal value. If so, the comparison can be stopped.

Because conductive wires have impedance and stray capacitances, even if the same initial driving signal values are provided to different electrodes, the initial capacitance signal values detected from the different electrodes will be different. The farther the electrode from the IC, the greater the initial capacitance signal value is detected from the electrode. An uneven distribution of the initial capacitance signal values may cause capacitance varying values detected from different electrodes, before and after the touches occurring on the touch panel, to distribute unevenly. An error or imprecise detection of the touch points may be caused by the unevenly distributed capacitance varying values, which may exceed the optimal detecting range of the IC. In the present disclosure, the initial capacitance signal value (the proximate capacitance signal value) of each electrode is selected to be closest to or equal to the basic capacitance signal value and the initial driving signal value corresponding to the proximate capacitance signal value is provided to the electrode. If the touch panel is touched, initial capacitance signal values of all electrodes vary from the basic capacitance signal value. Therefore, all of the varied initial capacitance signal values can be kept within the optimal detection range, and the initial capacitance signal values vary greatly. Therefore, the detection precision of the touch panel can be improved. On the other hand, the initial capacitance signal values of all electrodes are set to about the same level (the basic capacitance signal value). Correspondingly, the optimized driving signal values of every electrode are different. The farther the electrode from the IC, the greater the optimized driving signal value is provided to the electrode. Therefore, adverse effects caused by the impedance of the conductive wires and stray capacitances between the conductive wires can be reduced or eliminated.

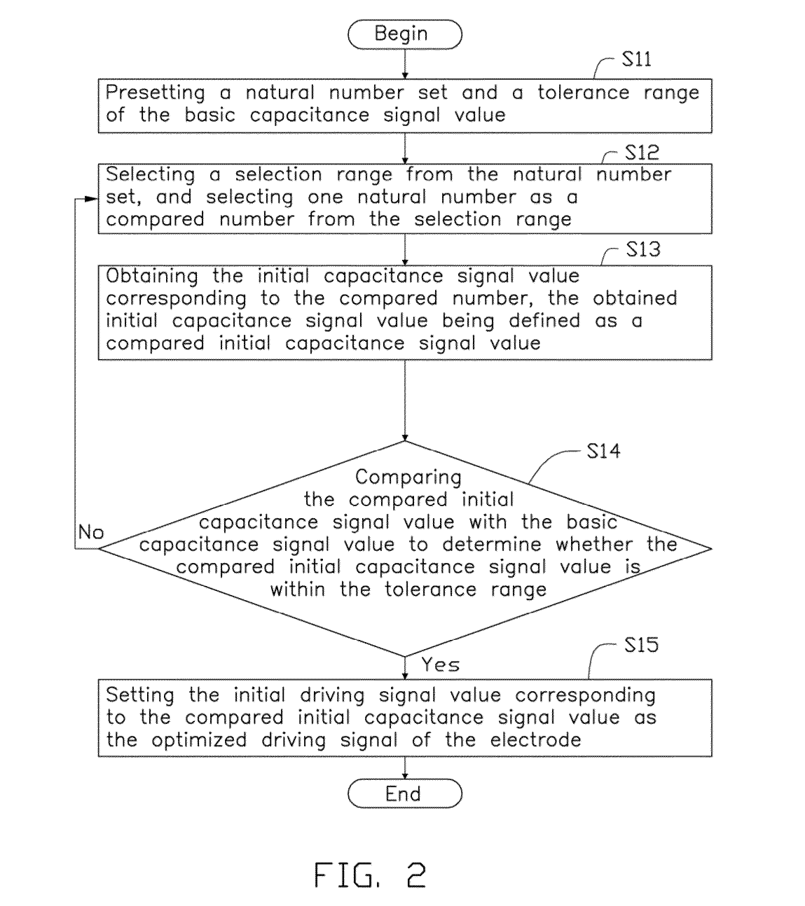

Referring to FIG. 2, the optimized driving signal value of each electrode can be set by the following steps:

S11, presetting a natural number set and a tolerance range of the basic capacitance signal value, the natural number set including a plurality of natural numbers, and the plurality of natural numbers corresponding one to one with the plurality of initial driving signal values, whereby the plurality of natural numbers correspond one to one with the plurality of initial capacitance signal values;

S12, selecting a selection range from the natural number set, and selecting one natural number as a compared number from the selection range;

S13, obtaining the initial capacitance signal value corresponding to the compared number as a compared initial capacitance signal value;

S14, comparing the compared initial capacitance signal value with the basic capacitance signal value to determine whether the compared initial capacitance signal value is in the tolerance range; and

S15, setting the initial driving signal value which corresponds to the compared initial capacitance signal value as the optimized driving signal of the electrode, if within the tolerance range; returning to the step S12 to select a new selection range and repeating the steps S12 to S15 until the optimized driving signal value is found, if not in the tolerance range.

In step S11, the plurality of natural numbers can have a one to one correspondence with the plurality of initial driving signal values. The plurality of natural numbers are numerical from low to high and the plurality of initial driving signal values are numerical from low to high. The greater the number of natural numbers, the more precisely they correspond to the plurality of initial driving signal values. The natural number set can be a set of natural numbers from 0 to 100. The natural number set also can be a set of even numbers or a set of odd numbers. In one embodiment, the natural number set is a set of natural numbers from 0 to 2^{t}−1, in which t is a natural number which can be arbitrarily selected. The natural number set can be considered as an equivalence of the varying driving signal. Values of the plurality of natural numbers can be proportionally equivalent or equal to the plurality of initial driving signal values. In one embodiment, the natural number set is {0, 1, 2, . . . 2^{t}−1}, and values of the natural numbers are used as digital signal values of the varying driving signal.

All capacitance signal values in the tolerance range are close to or equal to the basic capacitance signal value. The tolerance range can be a range of a difference or a ratio between the initial capacitance signal value and the basic capacitance signal value.

The selection range includes an upper limit value and a lower limit value. The step of selecting the selection range and selecting the compared number can be repeated several times to confirm the optimized driving signal value of the electrode. The first compared number selected can be at a central position value, one-third position value, or one-fourth position value of the natural number set. In one embodiment, the first selection range is the natural number set and the first compared number selected is a central value number of the natural number set. The central value number equals to ((the upper limit value−the lower limit value)/2).

In step S15, if the present compared initial capacitance signal value is smaller than the basic capacitance signal value, setting the present compared number as an upper limit value of the selection range when going back to step S12; and if the present compared initial capacitance signal value is greater than the basic capacitance signal value, setting the present compared number as a lower limit value of the selection range when going back to step S12.

Every time the new selection range selected is based on and further to narrow the selection range the next time.

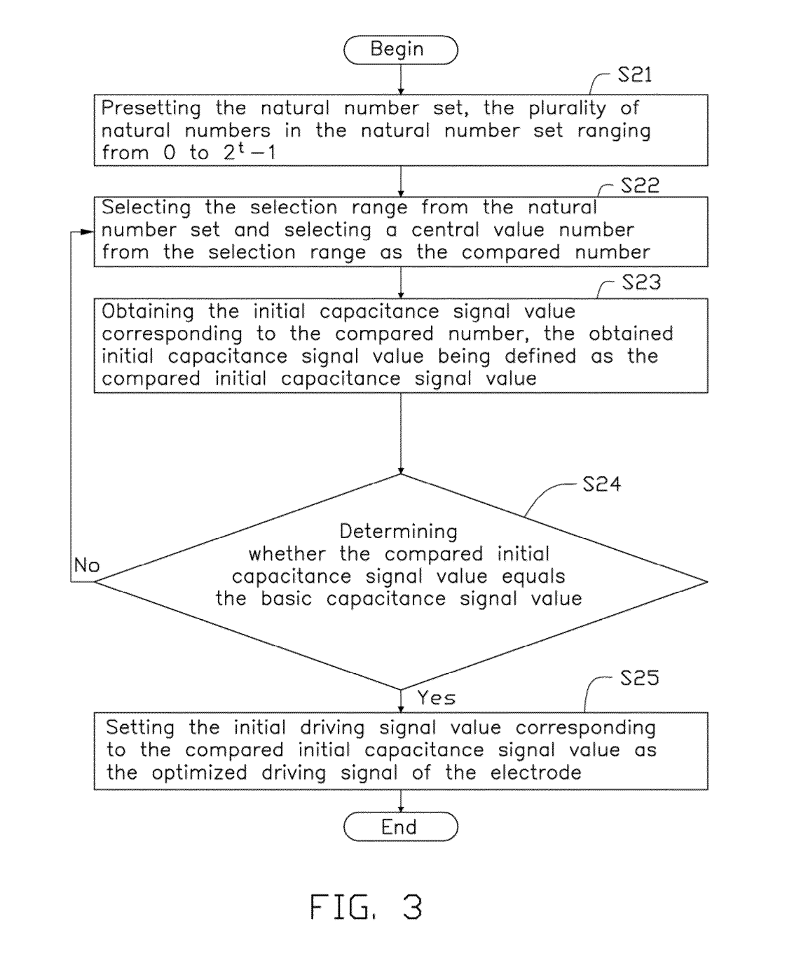

Referring to FIG. 3, one embodiment of a method setting the optimized driving signal value for each electrode of the touch panel comprises the following steps:

S21, presetting the natural number set, the plurality of natural numbers in the natural number set ranging from 0 to 2^{t}−1, t being a natural number, values of the plurality natural numbers corresponding one to one with the plurality of initial driving signal values, whereby the plurality of natural numbers corresponding one to one with the plurality of initial capacitance signal values in the order;

S22, selecting the selection range from the natural number set and selecting a central value from the selection range as the compared number;

S23, obtaining the initial capacitance signal value corresponding to the compared number as the compared initial capacitance signal value;

S24, determining whether the compared initial capacitance signal value equals the basic capacitance signal value;

S25, setting the compared initial capacitance signal value as the optimized driving signal of the electrode, if the compared initial capacitance signal value equals the basic capacitance signal value; returning to the step S22 to selecting the new selection range and repeating the steps S22 to S25 until the optimized driving signal value found, if not.

In one embodiment, the natural number set (0˜2^{t}−1) can be preset based on a precision of an analog digital convertor of the touch panel. In other words, the value of t can reflect the precision of the analog digital convertor. In another embodiment, t is unrelated to the precision of the analog digital convertor.

In step S22, the compared natural number selected every time is the central value number of the selection range. In one embodiment, the first selection range selected is the natural number set (0˜2^{t}−1).

In step S25, if the compared initial capacitance signal value is smaller than the basic capacitance signal value, the next selection range selected ranges from the lower limit value of the present selection range to the present central value number selected. If the compared initial capacitance signal value is greater than the basic capacitance signal value, the next selection range selected ranges from the present central value number to the upper limit value of the present selection range.

The selection range of every time is based on and narrows the selection range of last time to quickly search the optimized driving signal value of the electrode.

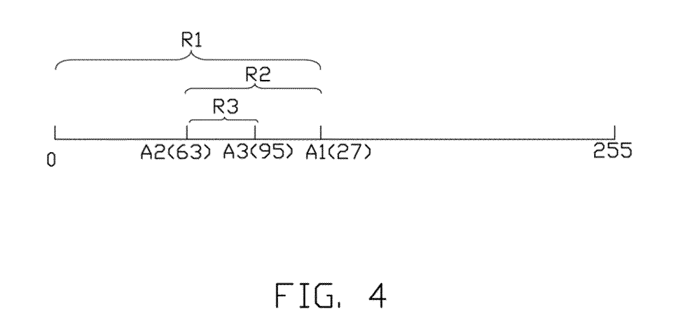

Referring to FIG. 4, one example for further illustrating the process of searching the optimized driving signal value of the electrode is provided. The natural number set is (0 to 255). The first compared natural number selected is the central value number 127 of (0 to 255), labeled as A1. If the initial capacitance signal value corresponding to the central value number 127 is smaller than the basic capacitance signal value, the next selection range is (0 to 127), labeled as R1. The compared natural number is the central value number 63 selected from R1 and labeled as A2. If the initial capacitance signal value corresponding to the A2 is greater than the basic capacitance signal value, the next selection range is (63 to 127) and labeled R2. The next compared natural number is 95. The initial capacitance signal value corresponding to 95 continues to compare with the basic capacitance signal value to further search the optimized driving signal value.

The steps S12 to S15 can be repeated k number of times, which can be further set in the method. If the number of times the central value number selected does not reach k number of times, the selection range can be selected again. If the number of times repeated reaches k number of times, the initial driving signal value corresponding to the number compared at the kth time is set as the optimized driving signal value of the electrode. Setting the k number of times of the central value can shorten the time period for searching the optimized driving signal value. The k can be related to the natural number set (0 to 2^{t}−1), such as k equals t. The greater the value of k, the more precise the optimized driving signal value set. In one embodiment, the time period for searching the optimized driving signal value of the electrode is shortened by selecting the central value number from the selection range every time and setting the k number of times of the central value number.

In the above methods, the tolerance range of the basic capacitance signal value can also be preset to further shorten the time period of searching the optimized driving signal value of the electrode.

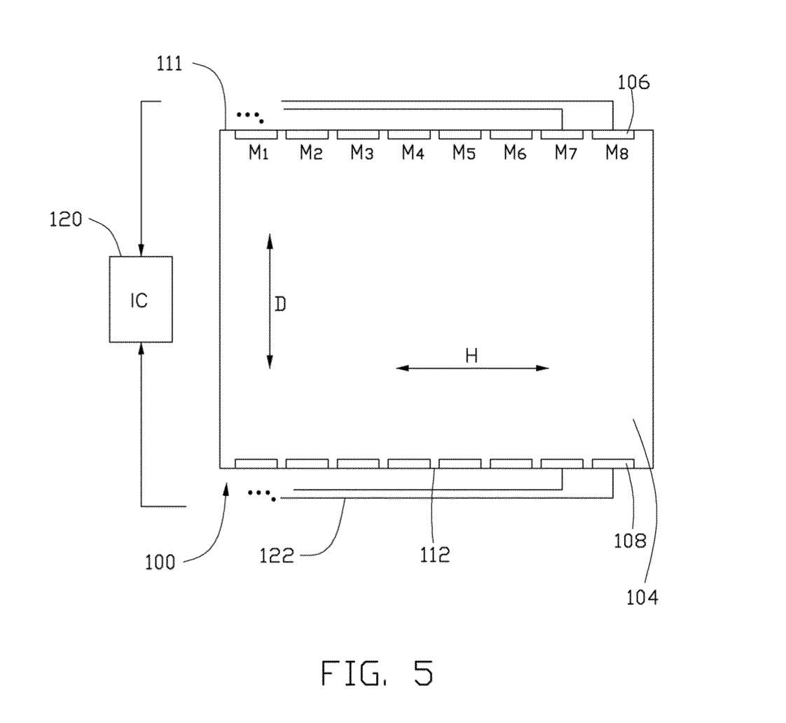

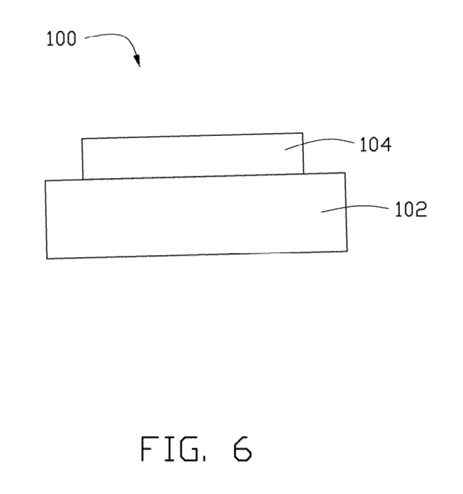

Referring to FIGS. 5 and 6, one embodiment of a capacitive touch panel 100 is provided for the method. The capacitive touch panel 100 includes a substrate 102, a transparent conductive film 104 disposed on a surface of the substrate 102, a plurality of first electrodes 106, and a plurality of second electrodes 108. The transparent conductive film 104 is an impedance anisotropic film. A relatively low impedance direction D and a relatively high impedance direction H are defined on a surface of the impedance anisotropic film. The relatively high impedance direction H is substantially perpendicular to the relatively low impedance direction D. The transparent conductive film 104 includes a first side 111 and an opposite second side 112. Both the first side 111 and the second side 112 extend along the relatively high impedance direction H. The plurality of first electrodes 106 are disposed along the first side 111 and spaced from each other. The plurality of second electrodes 108 are disposed along the second side 112 and spaced from each other. One end of each of the plurality of first electrodes 106 or one end of each of the plurality of second electrodes 108 is electrically connected with the transparent conductive film 104. The other end is electrically connected with an IC 120 via a conductive wire 122. The plurality of first electrodes 106 and the plurality of second electrodes 108 act as driving electrodes and sensing electrodes. In other words, driving signals are provided to the plurality of first electrodes 106 and second electrodes 108 by the IC 120 and sensing signals are also detected from the plurality of first electrodes 106 and second electrodes 108 in a touched or untouched condition of the capacitive touch panel 100. The sensing signals can be voltage signals, capacitance signals, current signals, or resistive signals. There are also other elements connected between the capacitive touch panel 100 and the IC 120 to ensure a normal working state. The method of setting driving signals for the electrodes is not influenced by the elements.

The substrate 102 may be made of a transparent material such as polyethylene (PE), polycarbonate (PC), polyethylene terephthalate (PET), polymethyl methacrylate (PMMA), glass, quartz, or diamond.

The conductivity of the transparent conductive film 104 along the relatively low impedance direction D is greater than conductivities of the transparent conductive film 104 along other directions. The electric conductivity of the transparent conductive film 104 along the relatively high impedance direction H is smaller than the electric conductivities of the transparent conductive film 104 along other directions. In one embodiment, the transparent conductive film 104 includes at least one carbon nanotube film. The at least one carbon nanotube film is drawn from a carbon nanotube array. A majority of carbon nanotubes in the at least one carbon nanotube film are joined end to end by van der Waals attractive forces along a same direction. The at least one carbon nanotube film is a free-standing structure. The term “free-standing structure” can be defined as a structure that does not need to be supported by a substrate. For example, a free standing structure can sustain the weight of itself when it is hoisted by a portion thereof without any significant damage to the structural integrity. So, if the at least one carbon nanotube film is placed between two separate supporters, a portion of the at least one carbon nanotube film, not in contact with the two supporters, would be suspended between the two supporters and yet maintain film structural integrity. The free-standing structure of the at least one carbon nanotube film is realized by the successive carbon nanotubes joined end to end by van der Waals attractive forces.

The majority of carbon nanotubes extending along the relatively low impedance direction D and the direction substantially perpendicular to the extending direction is the relatively high impedance direction H. The majority of carbon nanotubes is substantially parallel to each other and joined by van der Waals attractive force therebetween. In addition, a small amount of carbon nanotubes in the at least one carbon nanotube film are randomly arranged. The randomly arranged carbon nanotubes are electrically connected adjacent carbon nanotubes. Therefore, the conductivity still exists in the at least one carbon nanotube film along the relatively high impedance direction H. The transparent conductive film 104 can also be an indium tin oxide transparent conductive film including a plurality of indium tin oxide bars parallel with and spaced from each other.

The plurality of first electrodes 106 can be made of a conductive material. The conductive material can be metal, conductive polymer, carbon nanotubes, or indium tin oxide. The plurality of first electrodes 106 can be bar shaped, layered, or rod shaped. In one embodiment, the plurality of first electrodes 106 is bar shaped printed silver electrodes. A distance between adjacent first electrodes 106 can be in a range from about 3 millimeters to about 5 millimeters. The plurality of first electrodes 106 is substantially parallel to the relatively high impedance direction H in length. A length of each of the plurality of first electrodes 106 can be in a range from about 1 millimeter to about 5 millimeters. An amount of the plurality of first electrodes depends upon an area of the transparent conductive film 104. In one embodiment, there are eight first electrodes, each first electrode 106 is about 1 millimeter long, and the distance between adjacent first electrodes 106 is about 3 millimeters. Structures and a number of the plurality of second electrodes 108 are the same as the plurality of first electrodes 106.

### Example

The method is used to set the optimized driving signal value of one first electrode 106 of the capacitive touch panel 100 as an example. There are eight first electrodes 106, labeled as M₁, M₂, M₃, M₄, M₅, M₆, M₇, and M₈. In the method, a varying current signal numerically from low to high is provided to each electrode 106 in sequence. Referring to FIG. 7, there are eight initial capacitance signal value curves. Each curve corresponds to the varying current signal from one first electrode 106. Values of the vertical coordinate and the horizontal coordinate are digital signal values. The first electrode M₈ is farthest from the IC 120 along the conductive path. Therefore, the initial capacitance signal values from the electrode M₈ is at a maximum. The first electrode M₁ is the nearest to the IC 120 along the conductive path. Therefore, the initial capacitance signal values from the electrode M₁ is at a minimum. Referring to table 1, a whole process for searching the optimized driving signal value for the electrode M₁ is illustrated.

The basic capacitance signal value is set at about 5800. The natural number set is (0 to 2⁸−1), that is, 0 to 255. In addition, the k number of times is set at 8. Values of the natural numbers correspond to the varying current signal numerically from low to high. The first central value number selected is 127 and the corresponding initial capacitance signal value is 3122 which is smaller than the basic capacitance signal value of 5800. Therefore, the next selection range selected is (0 to 127) and the central value picked is 63 and further compared the initial capacitance signal value corresponding to 63 with the basic capacitance signal value. After eight cycles, the eighth central value is 64 and set as the optimized driving signal value of the electrode M₁.

TABLE 1

| | | | | | comparison | |
|---|---|---|---|---|---|---|
| | | | | | result of the | |
| | | | | | initial | |
| | | | | | capacitance | |
| | | | | | signal value | |
| | present | central | basic | initial | with the | next |
| | selection | value | capacitance | capacitance | basic | selection |
| comparison | range | number | signal | signal | capacitance | range |
| times | selected | selected | value | value | signal value | selected |
| 1^{st} time | 0~255 | 127 | 5800 | 3122 | < | 0~127 |
| 2^{nd} time | 0~127 | 63 | 5800 | 5939 | > | 63~127 |
| 3^{rd} time | 63~127 | 95 | 5800 | 4063 | < | 63~95 |
| 4^{th} time | 63~95 | 79 | 5800 | 4750 | < | 63~79 |
| 5^{th} time | 63~79 | 71 | 5800 | 5155 | < | 63~71 |
| 6^{th} time | 63~71 | 67 | 5800 | 5500 | < | 63~67 |
| 7^{th} time | 63~67 | 65 | 5800 | 5641 | < | 63~65 |
| 8^{th} time | 63~65 | 64 | 5800 | 5811 | Comparison | — |
| | | | | | stop | |

When a conductor, such as a finger, touches the capacitive touch panel 100, a coupling capacitance can be generated between the conductor and the transparent conductive film 104. The coupling capacitance will cause a signal variation detected from the first electrodes 104 and second electrodes 106 before and after the touch. The touch points can be detected according to the signal variation.

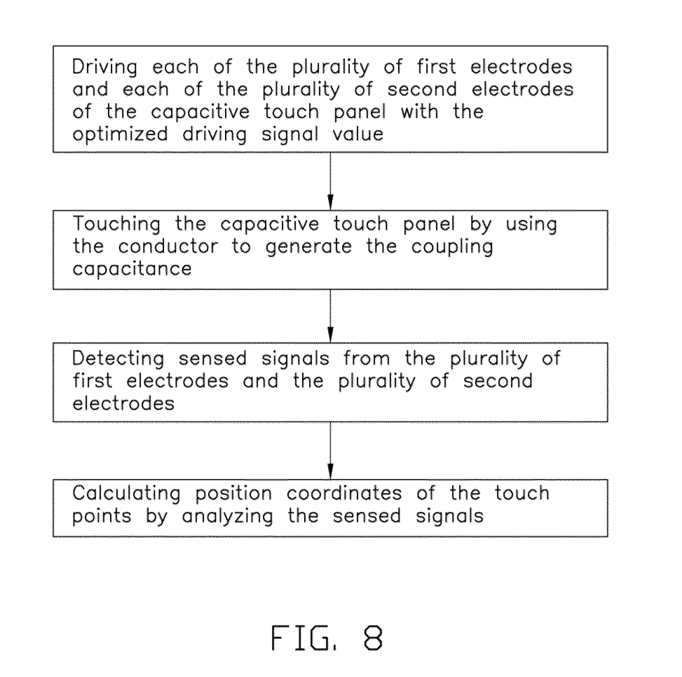

Referring to FIG. 8, one embodiment of a driving method for the capacitive touch panel 100 to detect the touch points comprises the following steps:

S31, driving each of the plurality of first electrodes 106 and each of the plurality of second electrodes 108 of the capacitive touch panel 100 with the optimized driving signal value;

S32, touching the capacitive touch panel 100 using the conductor to generate the coupling capacitance;

S33, detecting sensed signals from the plurality of first electrodes 106 and the plurality of second electrodes 108; and

S34, calculating position coordinates of the touch points by analyzing the sensed signals.

In step S31, each first electrode 106 and each second electrode 108 are driven by their corresponding optimized driving signal values. If there is no touch on the capacitive touch panel 100, the initial capacitance signal values detected from the plurality of first electrodes 106 and the plurality of second electrodes 108 are at the same level, which is the basic capacitance signal value. If there are touches on the capacitive touch panel 100, all sensed capacitance signal values vary based on the basic capacitance signal value. Therefore, the capacitance signal values detected from the electrodes near the touch points vary greatest and capacitance signal values detected from other electrodes vary slightly. Therefore, the position coordinates of the touch points can be easily and accurately sensed.

In step S33, the sensed signals can be voltage, current, electric quantity, capacitance, or a variation value thereof before and after touching. In one embodiment, the sensed signals are represented by a variation value curve of the capacitance. The variation value curve of the capacitance includes a plurality of capacitance variation values before and after touching the capacitive touch panel 100. The variation value curve of the capacitance detected from the plurality of first electrodes 106 is defined as a first curve, and the variation value curve of the capacitance detected from the plurality of second electrodes 108 is defined as a second curve.

In step S34, the position coordinates of the touch points can be calculated according to the sensed signals obtained before and after touching the capacitive touch panel 100. In one embodiment, a method for calculating the position coordinates of the touch points acted on the capacitive touch panel 100 comprises the following steps:

S341, calculating the position coordinates of the touch points in the relatively high impedance direction H according to the first curve or the second curve; and

S342, calculating the position coordinates of the touch points in the relatively low impedance direction D according to the first curve and the second curve.

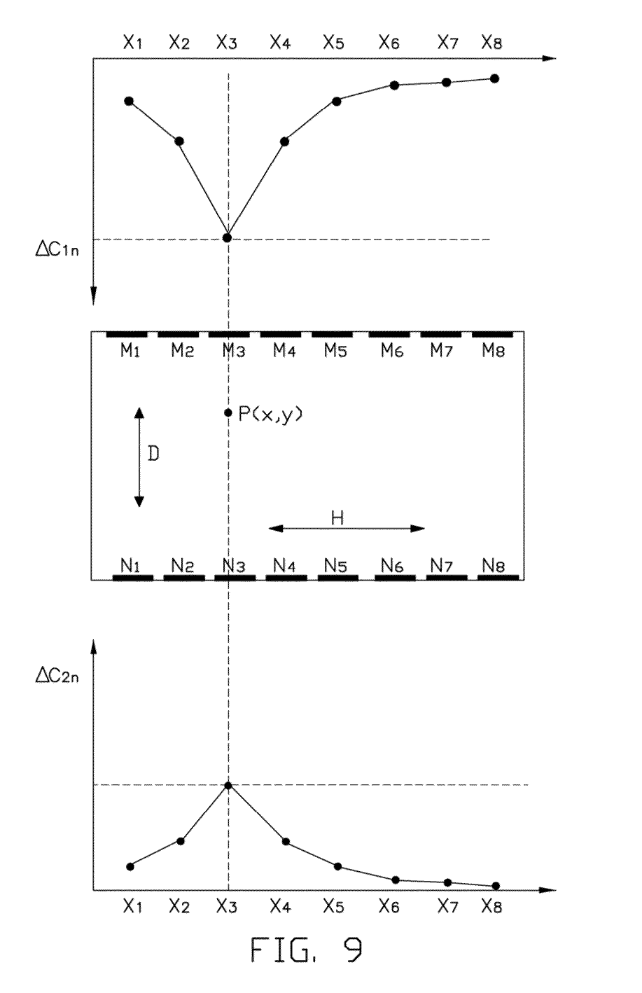

Referring to FIGS. 5 and 9, P represents a touch point acted on the capacitive touch panel 100. The position coordinate of the touch point P is represented by (xₚ, yₚ). yₚ represents a distance substantially perpendicular from the touch point P to the first side 111. The plurality of first electrodes 106 are labeled as M₁, M₂, M₃, M₄, M₅, M₆, M₇, and M₈. The plurality of second electrodes 108 are labeled as N₁, N₂, N₃, N₄, N₅, N₆, N₇, and N₈. The position coordinates of the plurality of first electrodes 106 and the plurality of second electrodes 108 in the relatively high impedance direction H are orderly labeled as X₁, X₂, X₃, X₄, X₅, X₆, X₇, and X₈. ΔV₁ᵢ represents the variation value of the capacitance detected from the first electrode Mᵢ before and after touching the capacitive touch panel 100. ΔV₂ᵢ represents the variation value of the capacitance detected from the second electrode Nᵢ before and after touching the capacitive touch panel 100, wherein i represents a number order of the first or second electrode, and i=1, 2, . . . 8.

(1) Calculating the Position Coordinate of the Touch Point P in the Relatively High Impedance Direction H

The position coordinate of the touch point P in the relatively high impedance direction H can be obtained from the first curve or the second curve. In one embodiment, one or more peak values in the first curve are found to calculate the position coordinate of the touch point P in the relatively high impedance direction H. Referring to FIG. 9, the variation value ΔV₁₃ detected from the M₃ is a peak value in the first curve. M₃ corresponds to the coordinate X₃. Therefore, the position coordinate xₚ of the touch point P can be directly determined from the first curve: xₚ=X₃. In addition, the variation values detected from the electrodes adjacent to the electrodes in which the peak values are detected can be used to calculate the position coordinates of the touch points for a better precision. For example, M₂ and M₄ are adjacent to M₃, the position coordinate xₚ of the touch point P can be calculated by a formula:

$${x}_{p} = \frac{{X}_{2} Δ {V}_{12} + {X}_{4} Δ {V}_{14}}{Δ {V}_{12} + Δ {V}_{14}} .$$

(2) Calculating the Position Coordinate of the Touch Point P in the Relatively Low Impedance Direction D

The one or more peak values in the first curve and in the second curve are found to calculate the position coordinate of the touch point P in the relatively low impedance direction D. The transparent conductive film 104 has an anisotropic impedance property. The closer the touch point to the first electrodes 106 or the second electrodes 108 in the relatively low impedance direction D, the greater the variation values detected from the corresponding first electrodes 106 or the corresponding second electrodes 108. Referring to FIG. 9, taking touch point P for example, a distance from the touch point P to the first electrode M₃ is smaller than the distance to the second electrode N₃, so the peak variation value ΔV₁₃ is greater than the peak variation value ΔV₂₃. The variation value is inversely proportional to the distance from the touch point to the corresponding first electrode 106 or second electrode 108. The position coordinate yₚ can be calculated by a formula:

$${y}_{p} = \frac{Δ {V}_{23}}{Δ {V}_{13} + Δ {V}_{23}} \times K ,$$

wherein K represents a distance substantially perpendicular from the first side 111 to the second side 112. In addition, the variation values detected from the electrodes adjacent to the electrodes from which the peak values were detected can be used to calculate the position coordinates of the touch points in the relatively low impedance direction D for a better precision. For example, the position coordinate yₚ can be represented by:

$${y}_{p} = \frac{Δ {V}_{22} + Δ {V}_{23} + Δ {V}_{24}}{Δ {V}_{13} + Δ {V}_{23} + Δ {V}_{12} + Δ {V}_{22} + Δ {V}_{14} + Δ {V}_{24}} \times K .$$

Other formulas can also be used to calculate the position coordinates of the touch points P. The above method can detect two more touch points.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A method for setting a driving signal for an electrode of a touch panel, the method comprising:
providing a varying driving signal to the electrode, the varying driving signal comprising a plurality of initial driving signal values varied with time;
detecting an initial capacitance signal value set from the electrode in an untouched condition of the touch panel, the initial capacitance signal value set comprising a plurality of initial capacitance signal values varied from each other, the initial capacitance signal value set being generated by and corresponding to the varying driving signal;
presetting a basic capacitance signal value;
selecting a proximate initial capacitance signal value from the initial capacitance signal value set, the proximate initial capacitance signal value being closest to the basic capacitance signal value; and
setting the initial driving signal value corresponding to the proximate initial capacitance signal value as an optimized driving signal value of the electrode.

2. The method of claim 1 further comprising repeating the detecting step to obtain a plurality of initial capacitance signal value sets and averaging the initial capacitance signal values in different initial capacitance signal value sets which corresponds to the same initial driving signal value to obtain an averaged initial capacitance signal value set.

3. The method of claim 1, wherein setting the optimized driving signal value of the electrode comprises:
(a) presetting a natural number set and a tolerance range of the basic capacitance signal value, wherein the natural number set comprises a plurality of natural numbers, and the plurality of natural numbers correspond one to one with the plurality of initial driving signal values, whereby the plurality of natural numbers correspond one to one with the plurality of initial capacitance signal values;
(b) selecting a selection range from the natural number set, and selecting one natural number as a compared number from the selection range;
(c) obtaining the initial capacitance signal value corresponding to the compared number, the obtained initial capacitance signal value being defined as a compared initial capacitance signal value;
(d) comparing the compared initial capacitance signal value with the basic capacitance signal value to determine whether the obtained initial capacitance signal value corresponding to the compared number is within the tolerance range; and
(e) setting the initial driving signal value which corresponds to the compared initial capacitance signal value as the optimized driving signal value of the electrode, if the obtained initial capacitance signal value is within the tolerance range; returning to the step (b) to select a new selection range and repeating the steps (b) to (e) until the optimized driving signal value is found, if the obtained initial capacitance signal value is not within the tolerance range.

4. The method of claim 3, wherein selecting the new selection range comprises: setting the current compared number of as an upper limit value of the next selection range, if the current compared initial capacitance signal value is smaller than the basic capacitance signal value; and setting the current compared number as a lower limit value of the next selection range, if the current compared initial capacitance signal value is greater than the basic capacitance signal value.

5. The method of claim 3, wherein the natural number set ranges from 0 to 2^{t}−1, t is a natural number, values of the plurality of natural numbers correspond one to one with the plurality of initial driving signal values numerically from low to high, thereby the plurality of natural numbers correspond one to one with the plurality of initial capacitance signal values; a central value number is selected from the selection range as the compared number; the compared initial capacitance signal value is determined whether it equals the basic capacitance signal value.

6. The method of claim 5, wherein selecting the new selection range comprises: if the compared initial capacitance signal value is smaller than the basic capacitance signal value, the next selection range selected ranges from the lower limit value of the current selection range to the current central value number selected; if the compared initial capacitance signal value is greater than the basic capacitance signal value, the next selection range selected ranges from the current central value number to the upper limit value of the current selection range.

7. The method of claim 5, further comprising repeating selecting the central value number if the compared initial capacitance signal value is not equal the basic capacitance signal value a predetermined number of times.

8. The method of claim 1, wherein the touch panel comprises at least one transparent conductive film, a material of the at least one transparent conductive film is carbon nanotubes or indium tin oxide.

9. A driving method for a touch panel comprising:
driving each electrode of the touch panel with an optimized driving signal value, wherein the optimized driving signal value of one electrode is set by:
providing a varying driving signal to the electrode, the varying driving signal comprising a plurality of initial driving signal values varied with time;
detecting an initial capacitance signal value set from the electrode in an untouched condition of the touch panel, the initial capacitance signal value set comprising a plurality of initial capacitance signal values varied from each other, wherein the initial capacitance signal value set is generated by and corresponding to the varying driving signal;
presetting a basic capacitance signal value;
selecting a proximate initial capacitance signal value from the initial capacitance signal value set closest to the basic capacitance signal value; and
setting the initial driving signal value corresponding to the proximate initial capacitance signal value as the optimized driving signal value of the electrode;
touching the touch panel by using a conductor to generate a coupling capacitance;
detecting sensed signals from each electrode; and
calculating position coordinates of at least one touch point by analyzing the sensed signals.
